(19) United States
(12) Patent Application Publication
(10) Pub. No.: US 2014/0070672 A1
(43) Pub. Date: Mar. 13, 2014

(54) VARIABLE RELUCTANCE RESOLVER HAVING INTEGRAL ELECTROMAGNETIC INTERFERENCE SHIELD AND ROTARY ELECTRIC MACHINE HAVING SAME

(71) Applicant: Remy Technologies, LLC, Pendleton, IN (US)

(72) Inventor: Richard Gale, Indianapolis, IN (US)

(21) Appl. No.: 14/021,265

(22) Filed: Sep. 9, 2013

Related U.S. Application Data
(60) Provisional application No. 61/698,497, filed on Sep. 7, 2012.

(51) Int. Cl. H02K 11/00; G01B 7/30

(52) U.S. Cl. CPC H02K 11/0005; H02K 11/0031; G01B 7/30
USPC 310/68 B; 324/207.16

(57) ABSTRACT

A variable reluctance resolver including a resolver stator having an annular resolver stator core surrounding an axis, a resolver rotor rotatable about the axis relative to the resolver stator and surrounded by the resolver stator core, and resolver EMI shielding. The resolver EMI shielding includes first and second resolver shields disposed on opposite axial sides of the resolver stator core. The resolver shielding has a relative permeability of at least about 50. Also, an electric machine having such a variable reluctance resolver.

### CROSS-REFERENCE TO RELATED APPLICATION(S)

This application claims the benefit under Title 35, U.S.C. §119(e) of U.S. Provisional Patent Application Ser. No. 61/698,497, entitled VARIABLE RELUCTANCE RESOLVER HAVING INTEGRAL ELECTROMAGNETIC INTERFERENCE SHIELD AND ROTARY ELECTRIC MACHINE HAVING SAME, filed Sep. 7, 2012 (Attorney Docket No. 22888-0054), the entire disclosure of which is expressly incorporated herein by reference.

### BACKGROUND

The present invention relates to rotary electric machines such as motors and generators, and particularly to variable reluctance resolvers used therein, and more particularly to a variable reluctance resolver in which the effect of external magnetism on output voltage is mitigated.

Contemporary rotary electric machines are increasingly using electronic controls and sensors such as resolvers to control the operation of the electric machines. Rotary electric machines typically have a stationary stator and a rotatable rotor that rotate relative to each other and are operably coupled to each other electromagnetically. Thus, the normal operation of rotary electric machines such as motors and generators creates electromagnetic fields. The operation of some of the electronic control and sensor components can be degraded by electromagnetic interference (“EMI”) generated by the operation of the electric machine.

A resolver is one type of device for detecting the rotary position of a rotating electric machine such as a motor or a generator, and may be used for determining the relative rotational speed between the machine rotor and the machine stator. Depending upon the application for which an electric machine is being manufactured, it may be desirable to operably couple a variable reluctance resolver with the machine rotor in order to know its angular position, and thus its speed. Such resolvers are often used to determine the rotational speed and/or angular position of a rotating shaft, and their use is well known to those having ordinary skill in the art. For example, in a generator/traction motor for a hybrid vehicle, resolvers are often used to determine the angular position of the rotor whereby a controller can utilize this information when controlling the operation of an inverter operably coupled with the generator/traction motor.

Resolvers are widely used as rotary position detection devices for rotary machinery used under poor conditions due to their relatively better ability, compared to alternative devices equipped with Hall elements or phototransistors, to be used in harsher environments. Such resolvers are typically disposed in positions adjacent to, for example, exciter windings of motors or generators arrayed within a machine housing, and electromagnetic noise generated by the excitation current which flows through these windings can sometimes be superimposed onto the resolver stator excitation coils or output coils. Consequently, an accurate rotary position and speed cannot be detected. Moreover, resolvers can be susceptible to damage due to mishandling prior to or during their installation into electric machines. Oftentimes, resolvers employ component plastic covers for protecting delicate or key functional areas of the resolver from handling damage.

A resolver typically includes a resolver stator having an inner circumference and a resolver rotor arranged radially inwardly of the resolver stator inner circumference. The resolver stator surrounds the resolver rotor and has a fixed position relative to the machine stator. The resolver rotor is arranged in a concentric manner with the machine rotor and rotates in uniformity with the machine rotor. One type of resolver is a variable reluctance resolver having excitation coils and output coils wound on the same multiple magnetic poles of the resolver stator. Multiple stator magnetic pole output coils are serially connected to obtain a single output coil output. Such variable reluctance resolvers are provided with multiple magnetic poles on the resolver stator, multiple teeth on the resolver rotor, an excitation coil, a first output coil which outputs the rotor X directional or sine component, and a second output coil which outputs the rotor Y axis or cosine component, with the output coils being wound on the relevant magnetic poles of the resolver stator.

When a magnetic field is applied from outside the resolver, there are frequent cases in which a magnetic flux caused by the external magnetic field mixes in with desired, variable magnetic field indicative of the relative positions between the relatively rotating resolver rotor and resolver stator. The external magnetic flux induces a voltage on each of the variable reluctance resolver stator output coils and generates an additional induced voltage on the output coil, degrading the accuracy of the variable reluctance resolver. Particularly where space constraints require the resolver to be in close proximity to sources of EMI, shielding must be employed to protect the resolver signals from the external interference source.

EMI shields of prior electric machines are formed of an electrically conductive and magnetically permeable material and typically separably assembled components of the machine, fixed in place using fasteners such as bolts and screws. Magnetic permeability refers to the ability of a material to support the formation of a magnetic field within itself. A magnetically permeable material will exhibit magnetization in response to an applied magnetic field. Magnetically permeability is measured in henrys per meter or newtons per ampere squared. The permeability constant, is defined as the permeability of free space, i.e., a vacuum. The relative permeability of a material is the ratio of the magnetic permeability of that material to the permeability constant. A high relative permeability indicates that the material has a greater ability to support the formation of a magnetic field within itself. Air has a relative permeability of approximately 1. Aluminum and stainless steel are generally considered to be non-magnetic and have a relative permeability falling in a range from about 1 to about 2; ferrous metal materials will generally have the ability to support a magnetic field within themselves and have a higher relative permeability. For example, carbon steel typically has a relative permeability of about 50 to 100. Highly magnetizable silicon steel, e.g., 4% Si Steel, will often have a relative permeability of at least about 2,000. Electrical steel typically has a relative permeability in a range from about 3,000 to about 8,000. Carbon steel having a relative permeability of at least about 50 could be employed to provide a magnetically permeable shield with EMI blocking properties which may be advantageous for some applications. The use of a silicon or electrical steel having a relative permeability of at least about 2,000, however, would provide greater EMI shielding properties but are relatively more expensive.

EMI shields for resolvers of electric machines are typically formed of a ferrous metal such as electrical steel stampings. Such shields provide the resolver with some degree of isolation from EMI, and are typically disposed proximate to and axially spaced from one of the axial end surfaces of the machine rotor core. In addition to the variable costs of the component machine shield itself and its associated fasteners, their use carries attendant variable and fixed costs associated with installing and inventorying these components. Moreover, shielding a variable reluctance resolver with separably installed component machine shields may cause the electric machine to increase in size. Furthermore, for such EMI shielding to be effective it is necessary to know the direction of the external magnetic flux and to place the machine shield where it will be effective, but there are many cases in which it is difficult to determine the most effective shield position. Additionally, it may be cost prohibitive or require unavailable package space within the machine to provide more effective shielding.

Improvements to prior resolver EMI shielding effectiveness that can be had without increasing space requirements within, or the size of, the electric motor, or which facilitate reductions in machine space requirements, and which can potentially reduce variable and fixed costs, would provide desirable advancements in the relevant art. Moreover, achieving such benefits in conjunction with providing protection for delicate or key functional areas of a resolver would provide additional advantages over prior resolvers and electric machines that employ them.

### SUMMARY

An electric machine including a resolver according to the present disclosure, and the resolver itself, beneficially achieves such advancements and advantages. The resolver EMI shielding disclosed herein is a component of the resolver, and may be an integral part of the resolver assembly; through its use, space and potentially cost can be saved, and more effective resolver shielding can be obtained. Moreover, utilizing such resolver shielding as a protective cover for guarding portions of the resolver against handling damage prior to or during its installation to the machine, instead of the above-mentioned plastic cover, eliminates the need for the separate protective cover used in prior resolvers, further facilitating reduced costs, space conservation within the electric machine, and possibly a reduction in the size of the machine itself.

In accordance with the present disclosure, a variable reluctance resolver has protective cover made of a material such as a low carbon steel or a steel with a higher relative permeability, or a plastic-type material with EMI shielding capability, the cover providing improved EMI shielding without increasing package space requirements relative to prior resolvers. A resolver having component EMI shields that also serve as a protective cover would be protected against handling damage prior to and during assembly and, relative to prior resolvers, be provided with additional capability to block or drain off interfering magnetic or electrical signals, thereby reducing the influence of the potential interference sources from coupling with the resolver signals, improving the accuracy of the resolver.

Further, by having such EMI shields as integral components of the resolver itself, packaging space for separably installed machine shield components can be avoided. Indeed, such machine shields and their mounting fasteners can possibly be eliminated, thereby presenting cost and space reduction opportunities without attendant resolver EMI shielding reduction. Alternatively, already existing machine shield components may remain and be supplemented by the component resolver shielding.

According to the present disclosure, the resolver stator is securely affixed within the electric machine housing without additional components, and while maintaining and/or reducing the radial and/or axial packaging dimensions of prior resolvers, while enhancing resolver EMI isolation. Therefore, an electric machine according to the present disclosure is suitable for use in applications in which space therefor is limited and improved EMI shielding is desired.

According to the present disclosure, an electric machine includes a machine stator and a machine rotor rotatable relative to each other, and a variable reluctance resolver for determining the angular position of the machine rotor with respect to the machine stator, the resolver having a resolver stator and a resolver rotor. The resolver stator includes a protective cover which guards against handling damage to the resolver, and which defines a component shield of magnetically permeable material having a relative permeability of at least about 50. The protective cover thus provides the resolver with an integral shield against EMI.

In addition to improving EMI shielding for the resolver, in some embodiments the component protective cover is an integral part of the resolver itself, specifically an integral part of the resolver stator, thereby allowing the axial dimension of the required resolver packaging space to be minimized, which allows an electric machine according to the present disclosure to have at least one reduced dimension relative to prior machines.

The present disclosure provides an electric machine including a machine stator, a machine rotor supported for relative rotation relative to the machine stator about an axis, and a variable reluctance resolver. The variable reluctance resolver includes a resolver stator having an annular resolver stator core rotatably fixed relative to the machine stator and surrounding the axis, and a resolver rotor rotatable in unison with the machine rotor and surrounded by the resolver stator core. The machine includes resolver EMI shielding having first and second resolver shields disposed on opposite axial sides of the resolver stator core. The resolver shielding has a relative permeability of at least about 50.

A further aspect of the electric machine is that the first and second resolver shields are separably assembled components of the electric machine.

A further aspect of the electric machine is that the first and second resolver shields are components of the variable reluctance resolver.

Another aspect of the electric machine is that the first and second resolver shields are separable components of the resolver stator.

Another aspect of the electric machine is that the first and second resolver shields are integrally formed together and joined through the resolver stator core. Accordingly, the first and second resolver shields are nonseparably integrated components of the resolver stator.

A further aspect of the electric machine is that wherein the resolver EMI shielding is formed of a plastic-type material having a relative permeability of at least about 50 and the first and second resolver shields are integrally formed together and joined through the resolver stator core.

A further aspect of the electric machine is that it also includes a machine shield located between the machine rotor and the variable reluctance resolver, the machine shield having a relative permeability of at least about 50. Accordingly, EMI shielding of the variable reluctance resolver by the machine shield is supplemented by the resolver EMI shielding.

A further aspect of the electric machine is that it also includes a machine housing within which the machine stator, the machine rotor, and the variable reluctance resolver are disposed, the machine housing and machine stator rotatably fixed relative to each other, the resolver stator core and the resolver EMI shielding affixed to the machine housing.

A further aspect of the electric machine is that the first and second resolver shields have flanges that superpose a respectively adjacent one of the opposite axial sides of the resolver stator core, the resolver stator core sandwiched between the flanges of the first and second resolver shields.

A further aspect of the electric machine is that the resolver rotor has an inner perimeter and an outer perimeter interfacing the resolver stator core and radially outward of the inner perimeter, and at least one of the first and second resolver shields has a circumference radially inward of the resolver rotor outer perimeter.

A further aspect of the electric machine is that the resolver rotor includes a resolver rotor core having a first magnetic permeability and an isolating sleeve disposed radially between the resolver rotor core and the axis, the isolating sleeve having a second magnetic permeability substantially less than the first magnetic permeability.

Another aspect of the electric machine is that the relative permeability of the isolating sleeve is no more than about 2.

The present disclosure also provides a variable reluctance resolver including a resolver stator having an annular resolver stator core surrounding an axis, a resolver rotor rotatable about the axis relative to the resolver stator and surrounded by the resolver stator core, and resolver EMI shielding. The resolver EMI shielding includes first and second resolver shields disposed on opposite axial sides of the resolver stator core. The resolver shielding has a relative permeability of at least about 50.

A further aspect of the variable reluctance resolver is that the first and second resolver shields are separable components of the resolver stator.

A further aspect of the variable reluctance resolver is that the first and second resolver shields are integrally formed together and joined through the resolver stator core. Accordingly, the first and second resolver shields are nonseparably integrated components of the resolver stator.

A further aspect of the variable reluctance resolver is that the resolver EMI shielding is formed of a plastic-type material having a relative permeability of at least about 50 and the first and second resolver shields are integrally formed together and joined through the resolver stator core.

A further aspect of the variable reluctance resolver is that the first and second resolver shields have flanges that superpose a respectively adjacent one of the opposite axial sides of the resolver stator core, the resolver stator core sandwiched between the flanges of the first and second resolver shields.

A further aspect of the variable reluctance resolver is that the resolver rotor has an inner perimeter and an outer perimeter interfacing the resolver stator core and radially outward of the inner perimeter, and at least one of the first and second resolver shields has a circumference radially inward of the resolver rotor outer perimeter.

A further aspect of the variable reluctance resolver is that the resolver rotor includes a resolver rotor core having a first magnetic permeability and an isolating sleeve disposed radially between the resolver rotor core and the axis. The isolating sleeve has a second magnetic permeability substantially less than the first magnetic permeability.

Another aspect of the variable reluctance resolver is that the relative permeability of the isolating sleeve is no more than about 2.

### BRIEF DESCRIPTION OF THE DRAWINGS

The above mentioned and other features of this invention, and the manner of attaining them, will become more apparent and the invention itself will be better understood by reference to the following descriptions of embodiments of the invention taken in conjunction with the accompanying drawings, wherein:

FIG. 1 is a partial cross-sectional side view of a first embodiment electric machine including a first embodiment resolver;

FIG. 2 is a partial cross-sectional side view of a second embodiment electric machine including a second embodiment resolver;

FIG. 3 is a cross-sectional side view of the resolver included in the electric machine of FIG. 2;

FIG. 4 is a front view of the resolver of FIG. 3;

FIG. 5 is a rear view of the resolver of FIG. 3; and

FIG. 6 is a modified rear view of the resolver of FIG. 5 shown with its integral rear shield portion omitted, revealing exemplary resolver stator and resolver rotor structures employed in the exemplary first and second embodiment resolvers.

Corresponding reference characters indicate corresponding parts throughout the several views. Although each exemplification set out herein illustrates an embodiment of the invention, in one form, the embodiments disclosed are not intended to be exhaustive or to be construed as limiting the scope of the invention to the precise forms disclosed. Moreover, the drawings are not necessarily to scale or to the same scale and certain features may be exaggerated in order to better illustrate and explain the present disclosure.

### DETAILED DESCRIPTION OF EXEMPLARY EMBODIMENTS

In the following description, words such as upper, lower, left, right, upward, downward, top, and bottom for describing positional relationships between respective members and directions merely indicate positional relationships and directions in the drawings. Such words do not indicate positional relationships and directions of the member mounted in an actual apparatus. Also, note that the reference numerals, figure numbers and supplementary descriptions are shown below for assisting the reader in finding corresponding components in the description of the embodiments below to facilitate the understanding of the present disclosure. It should be noted that these expressions in no way restrict the scope of the present invention.

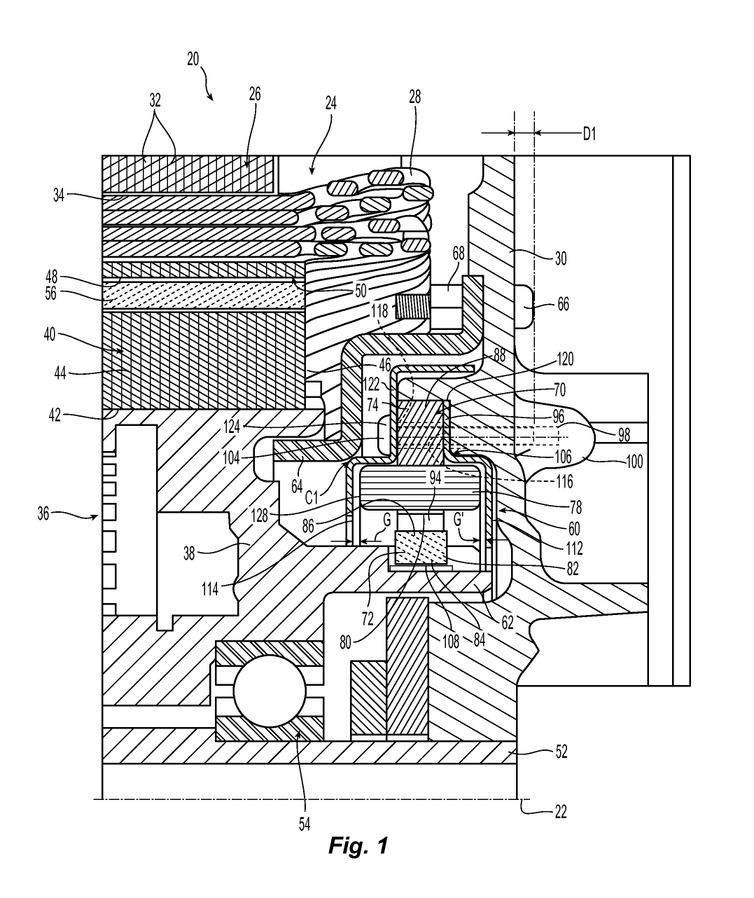

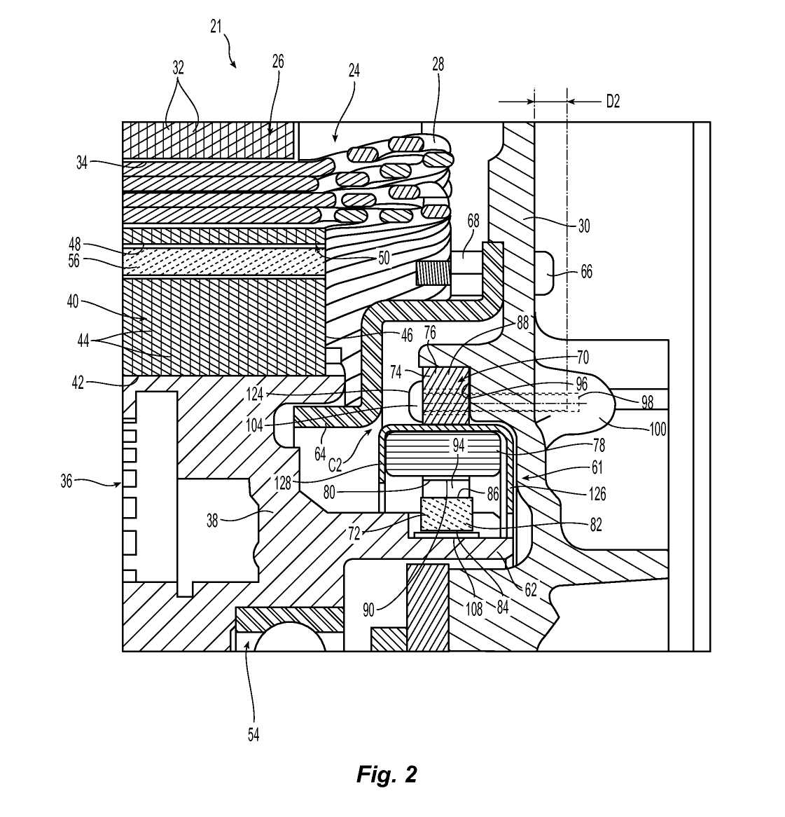

Electric machines 20, 21 according to first and second embodiments are depicted in FIGS. 1 and 2, respectively. It is also noted that FIG. 1 is a partial view which has been simplified for purposes of graphical clarity and does not depict that half of electric machine 20 below rotational axis 22 and omits portions of electric machine above axis 22. FIG. 2 provides a similar view of electric machine 21, excluding axis 22. Each of electric machines 20 and 21 includes machine stator 24 having machine stator core 26 and machine stator windings 28 mounted within housing 30. Stator 24 has a conventional structure, with stator core 26 being formed of a plurality of stacked metal laminae 32 and having generally axially extending slots 34 for receiving windings 28. Machine stator 24 is manufactured using conventional techniques well-known to those having ordinary skill in the art. Stator core 26 may be formed by stacking laminae 32 of electrical steel which are stamped out of sheet metal in a progressive die assembly. Wire wound into coils is then inserted in slots 34 in stator core 26 to form windings 28.

Each of electric machines 20 and 21 also includes machine rotor 36 rotatable relative to machine stator 24. Machine rotor 36 includes machine rotor hub 38 on which machine rotor core 40 is mounted and rotationally fixed. Rotor hub 38 may be a weldment formed out of a high hardenability gear steel and a nickel steel. Rotor core 40 has central bore 42 which has an interference fit with rotor hub 38 that may be obtained in the manner described below. Rotor core 40 has a conventional structure and is formed by a plurality of stacked metal laminae 44. Laminae 44 on the opposite axial ends of rotor core 40 define opposite axial end surfaces 46 of rotor core 40 (one of which is shown). Rotor core 40 defines a plurality of axially extending slots 48 that define openings 50 in each axial end surface 46 of rotor core 40. Machine rotor 36 is manufactured using conventional technologies well-known to those having ordinary skill in the art. Techniques for forming rotor core 40 may be similar to those used in forming stator core 26. For example, rotor core 40 may be formed of a plurality of electrical steel laminae 44 stamped and stacked in a progressive die assembly. The progressive die assembly is used to stamp slot openings in each of laminae 44 used to form rotor core 40, and laminae 44 are aligned so that the stamped openings in laminae 44 form axially extending slots 48 when laminae 44 are stacked. These openings in the opposite axial end surfaces 46 of rotor core 40 thus define openings 50 to axially extending slots 48.

Thus, stator core 26 and rotor core 40 of electric machines 20, 21 are formed out of stacked electrical steel laminae 32, 44. The electrical steel laminae are formed out of an iron alloy and typically include silicon in amounts which may range up to approximately 6.5% but are typically no greater than approximately 2% to 3.2%. Magnesium and aluminum, in amounts up to approximately 0.5%, may also be used in electrical steel. Electrical steel is widely available and well-known to those having ordinary skill in the art. The respective laminae 32, 44 forming machine stator core 26 and machine rotor core 40 can be secured together by welding, adhesives, inter-engaged tabs and slots in adjacent laminae, or by other suitable methods. For example, one adhesive method of securing laminae involves the use of a two part epoxy wherein one part is applied to the bottom surface of each of the laminae and the other is applied to the top surface of each of the laminae. Once stacked, the laminae are heated to adhere the two parts together and form a bonded core 32 or 44.

Rotor core 40 can be mounted on rotor hub 38 with an interference fit by differentially applying thermal energy to rotor core 40 versus rotor hub 38. For example, rotor core 40 can be heated to cause its thermal expansion and thereby allow hub 38 to be inserted into the central opening of rotor core 40. Hub 38 can also be cooled to further facilitate the mounting of rotor core 40 thereon.

Magnets 56 are disposed in slots 48 and are made of a material that is capable of acting as a permanent magnet when installed in rotor core 40. Magnets 56 may either be magnetized prior to installation in rotor core 40, or may be non-magnetized when installed and have magnetic properties imparted to them after installation in rotor core 40. Magnets 56 may be advantageously formed out of neodymium iron boron. Dysprosium may be included when forming magnets 56 to provide greater temperature stability and allow the magnetic material to better resist the loss of magnetism. A variety of other materials may also be used to form magnets 56 including rare earth materials such as lithium, terbium and samarium. The use of these and other magnetic materials to form permanent magnets for use in electric machines is well-known to those having ordinary skill in the art. Magnets 56 may also include an outer layer of material such as a layer of nickel formed on the magnetic material by electroplating or a layer of aluminum formed by vapor diffusion that forms an outer coating on the magnet. Such outer coatings can be used to enhance resistance to corrosion. Magnets 56 may be installed in slots 48 after heating rotor core 40 and retained therein by an interference fit. For example, rotor core 40 can be heated to thermally expand the size of rotor core 40, and slots 48, providing sufficient clearance for magnets 56 to be inserted into slots 48. Magnets 56 may also be chilled to reduce their dimensions. Rotor core 40 and magnets 56 are then allowed to return to ambient temperature. Rotor core 40 and magnets 56 are dimensioned such that magnets 56 are firmly engaged by rotor core 40 and secured therein when core 40 and magnets 56 are at the same temperature. Hub 38, rotor core 40, and magnet 56 can be dimensioned so that once rotor core 40 is positioned on hub 38 and these parts are allowed to return to ambient temperature, they will be tightly interengaged and fixed together. Alternatively, magnets 56 can be retained in slots 48 by means of an adhesive, by a press-fit engagement with rotor core 40, or other suitable means.

As illustrated, rotor core slots 48 are fully encircled by the material forming rotor core 40. Alternatively, slots 48 could extend outwardly to the outer radial perimeter of rotor core 40 and thereby form open-ended slots with an opening that extends axially along the outer radial surface of rotor core 40. Alternatively, rotor 36 could include magnets 56 that are attached at the outer radial surface of rotor core 40 instead of in axially extending slots.

Machine 20, 21 includes ground sleeve 52 fixed to housing 30 and extending parallel with and concentrically about rotational axis 22. Bearing assemblies 54 disposed about ground sleeve 52 rotationally support rotor hub 38 radially and axially relative to axis 22, about which machine rotor 36 rotates relative to housing 30. In some applications, a clutch assembly (not shown) is used to selectively engage rotor hub 38 with an external shaft (not shown) coupled to the drive system of a vehicle, whereby electric machine 20, 21 can be selectively engaged as either a traction motor or generator.

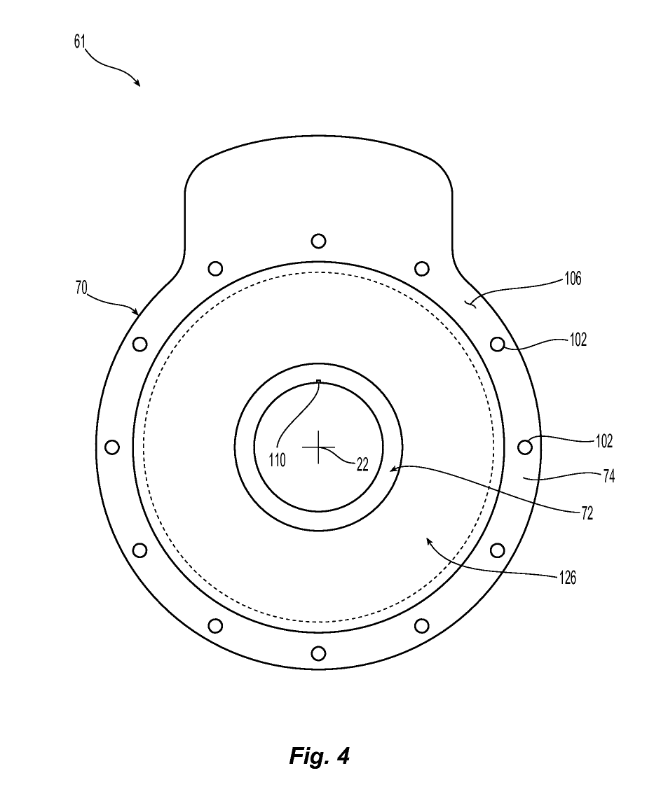

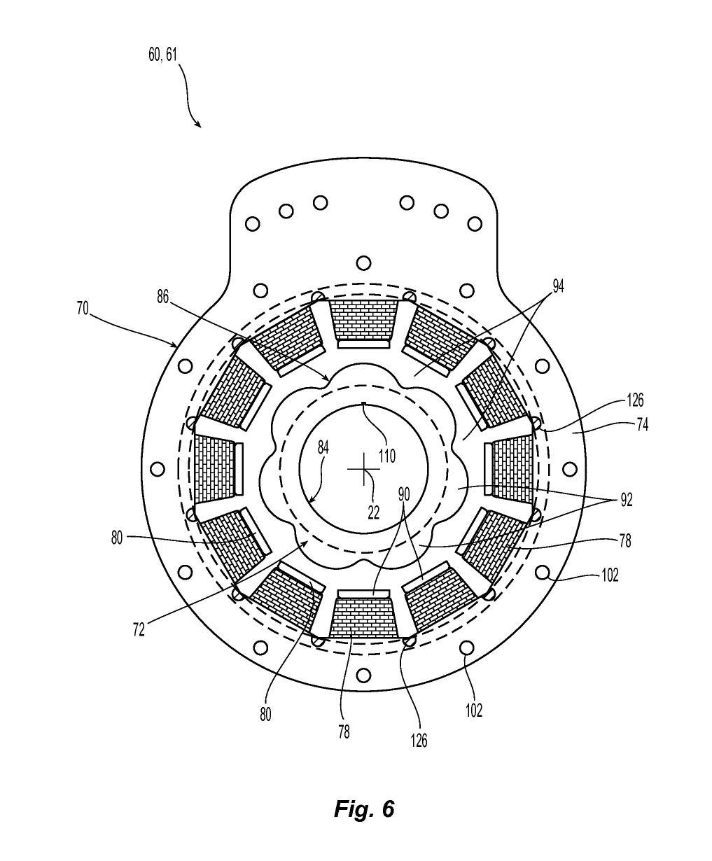

In first and second embodiment electric machines 20, 21, a respective first or second embodiment resolver 60, 61 according to the present disclosure is operably coupled with machine rotor 36. The basic structure of first embodiment resolver 60 is shown in FIGS. 1 and 6, whereas the basic structure of second embodiment resolver 61 is shown in FIGS. 2-6. At an axial end of rotor hub 38 is cylindrical projection or stub 62. Resolver 60, 61 is coupled with rotor hub stub 62 and housing 30 for determining the position and speed of machine rotor 36 relative to machine stator 24 during machine operation. As shown in FIGS. 1 and 2, each of first and second embodiment electric machines 20 and 21 includes machine shield 64 disposed between machine rotor 36 and resolver 60, 61. As discussed above, machine shield 64 typically is a separately assembled component of machine 20, 21 and has a relative permeability of at least about 50. Machine shield 64 is affixed to housing 30 with fasteners such as screws 66 and nuts 68. As discussed above, although machine shield 64 is typically employed in prior electric machines to shield prior resolvers from EMI, in accordance with the present disclosure shield 64 may be unnecessary for use with resolvers 60, 61 in machines 20, 21, and shield 64 may be omitted entirely or used in conjunction with a resolver 60, 61. Thus, electric machines 20, 21 optionally include machine shield 64.

Each resolver 60, 61 has resolver stator 70 disposed about axis 22 and affixed to an interior surface of housing 30, and a resolver rotor 72 affixed to rotor hub stub 62. Resolver stator 70 defines a circular ring 74 that is concentric with and surrounds resolver rotor 72. Resolver stator 70 and resolver rotor 72 are substantially co-located axially along axis 22. Resolver rotor 72 is annular and formed of stacked electrical steel laminae 82 that define circular inner perimeter 84 and outer perimeter 86 of resolver rotor 72. Substantially annular resolver stator ring 74 is defined by core 88 formed of stacked electrical steel laminae 76. Core 88 has a plurality (for example, twelve in the disclosed embodiments) of circumferentially spaced teeth 90 each extending radially inwardly towards axis 22, with the terminal end of each tooth 90 forming a gap 94 with radially interfacing resolver rotor outer perimeter 86. Each tooth 90 defines a resolver stator pole 80 about which resolver stator windings 78 are wound.

Electric machine housing 30 includes a flat, circular interior surface portion 96 disposed about axis 22. Portion 96 has a circular array of holes 98 extending into axially projecting housing bosses 100. Holes 98 may be tapped to engage screw threads and are aligned with a circular array of clearance holes 102 that extend axially through resolver stator core 88 at locations radially outward of its teeth 90. Suitable fasteners 104 such as headed screws extend through stator clearance holes 102 and engage holes 98, thereby fixing resolver stator 70 to machine housing 30 such that resolver stator front face 106 superposes housing interior surface portion 96. The positions of resolver stator 70 and machine stator 24 are thus fixed relative to each other via portions of a retaining mechanism which, in the disclosed embodiments, includes fasteners 104 and aligned holes 98, 102.

Machine hub 38 and resolver rotor 72 can be dimensioned such that in some electric machine embodiments resolver rotor 72 can be installed onto rotor hub 38 by an interference fit, which may be obtained by heating resolver rotor 72 to enlarge the inner diameter dimension defined by resolver rotor inner perimeter 84 and then disposing resolver rotor 72 about machine rotor hub stub 62, and then letting resolver rotor 72 cool and inner perimeter 84 to shrink. The resolver rotor 72 and machine rotor hub 38, once equalized at ambient temperature, are firmly interengaged and remain rotationally fixed together. In achieving this interference fit, it may also be desirable to chill rotor hub 38 to provide further clearance when disposing heated resolver rotor 72 thereabout. Notably, the assembly of both machine rotor core 40 and resolver rotor 72 to rotor hub 38 may be done as part of a single operation. Alternative methods of fixing machine rotor core 40 and/or resolver rotor 72 to machine rotor hub 38 could also be employed. For example, either could be welded or keyed to machine rotor hub 38. For example, resolver rotor 72 may include a radially inwardly extending keyway 110 in which is received a key (not shown) that engages rotor hub 38 to prevent rotational slipping of resolver rotor laminae 82 relative to machine rotor 36.

In certain electric machine embodiments, however, it may be preferable that resolver rotor 72 is magnetically isolated from rotor hub stub 62, and that the mounting structure therebetween be substantially non-conductive and/or of low relative permeability, preferably no greater than about 2. Such a mounting structure can isolate resolver rotor 72 from rotor hub 38 by preventing direct contact between hub 38 and resolver rotor laminae 82. Cylindrical isolating sleeve 108 may be disposed between, and used to substantially magnetically isolate, resolver rotor laminae 82 from rotor hub stub 62. Isolating sleeve 108 may be formed of a low relative permeability material such as aluminum or stainless steel to inhibit the transfer of magnetic flux from rotor hub 38 to resolver rotor 72. Isolating sleeve 108 may be a component of resolver rotor 72, with resolver rotor laminae 82 fixedly mounted to isolating sleeve 108 through, for example, a press-fit engagement between resolver rotor inner perimeter 84 and the radially outer cylindrical surface of sleeve 108. Resolver rotor laminae 82 are preferably mounted onto isolating sleeve 108 with only a light press-fit to avoid imparting stresses to resolver rotor 72, which might distort the magnetic flux generated therein during operation of resolver 60, 61. Resolver rotor 72 may then be mounted to rotor hub 38 in a manner described above, such that its isolating sleeve 108 will not rotate or axially slide relative to rotor hub 38. Preferably, rotor laminae 82 are also prevented from axially contacting rotor hub 38 via a substantially magnetically permeable pathway by any convenient means, such as by isolating sleeve 108, or by constraining resolver rotor 72 against axial movement along rotor hub stub 62.

Resolver rotor outer perimeter 86 has a wave form shape that defines a plurality (for example, seven in the disclosed embodiments) of circumferentially distributed protrusions or peaks 92 between which are valleys. Referring to FIG. 6, during operation of machine 20, 21, the radial distances or gaps 94 between each resolver stator pole 80 and resolver rotor outer perimeter 86 varies with the rotational position of resolver rotor 72 depending on the proximity of the wave form peaks and valleys of resolver rotor outer perimeter 86. The magnetic flux and current induced in the respective coils of resolver stator winding 78 consequently varies with changes in radial gaps 94 between resolver rotor outer perimeter 86 and resolver stator poles 80 as resolver rotor 72 moves relative to resolver stator 70.

Resolver stator windings 78 may include a resolver excitation coil wound about all resolver stator poles 80, and/or X and Y output coils wound about their respective poles 80, as described above or in another manner known to one having ordinary skill in the relevant art. Wiring (not shown) conveys signals from the output coils of resolver stator windings 78 to a control unit (not shown). During operation of machine 20, 21, variations in magnetic flux between resolver rotor 72 and resolver stator poles 80 induce current variations in windings 78, which allow the rotational position and thus the speed of resolver rotor 72 relative to resolver stator 70 to be determined by the control unit. The control unit regulates the output or input of the electrical machine, as the case may be, as described above or in another manner known to one having ordinary skill in the relevant art. Resolver 60, 61 thus facilitates the operational control of electric machine 20, 21.

Referring to FIG. 1, first embodiment resolver 60 is utilized with front and rear shields 112, 114, which may be components of resolver stator 70 and installed therewith into machine 20. Alternatively, front and rear shields 112, 114 may be separably assembled components of machine 20. Shields 112, 114 are respectively provided with a circular array of clearance holes 116, 118 in their flange portions 120, 122. Flange portions 120, 122 sandwich resolver stator core 88 therebetween, and clearance holes 116, 118 are aligned with clearance holes 102 that extend through resolver stator core 88. Shields 112, 114 are thus positioned relative to resolver stator core 88 and machine housing 30 with abovementioned fasteners 104. Fasteners 104 may be headed screws that extend through aligned shield clearance holes 116, 118, and resolver stator core clearance holes 102, and engage tapped holes 98 in machine housing surface portion 96. Front shield flange portion 120 is sandwiched between resolver stator core 88 and housing surface portion 96. Rear shield flange portion 122 is sandwiched between resolver stator core 88 and heads 124 of screws 104. Shields 112, 114 are formed of a material having a relative permeability of 50 or greater.

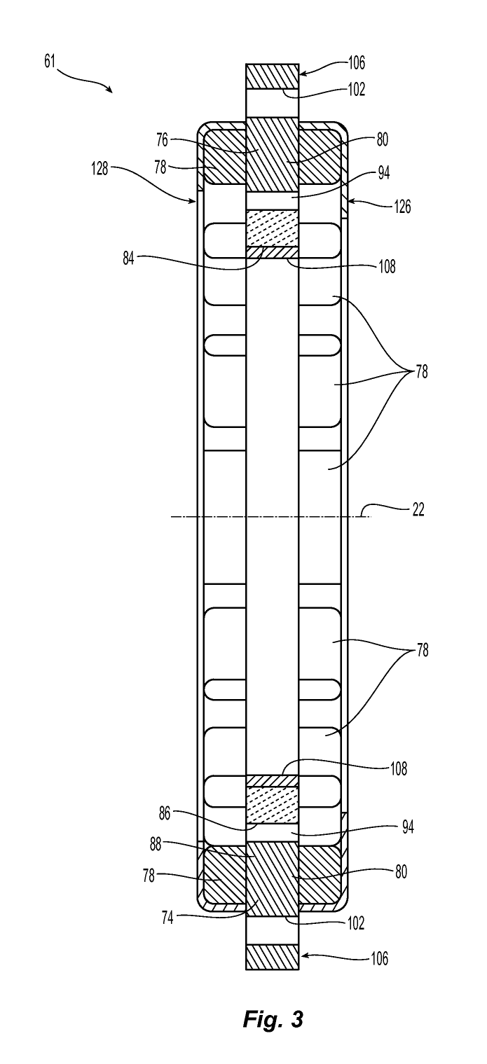

Referring to FIGS. 2 and 3, second embodiment resolver 61 is utilized with shields 126, 128 which are integrally formed together of plastic-type material having a relative permeability of 50 or greater, and joined through resolver stator core 88. Front and rear shields 126, 128 are thus nonseparably integrated components of resolver stator 70, and thus components of resolver 61. The integration of shields 126, 128 into resolver stator 70 in second embodiment resolver 61 affords greater compactness vis-à-vis first embodiment resolver 60, for gaps G and G′ (FIG. 1) are eliminated, all else held equal. This reduction in axial packaging dimensions increases the clearance between machine shield 64 and the respective rear shield 114, 128 from C1 to C2, as shown by comparing FIGS. 1 and 2. The axial space reduction is also shown by comparison of distances D1 and D2 in these two Figures.

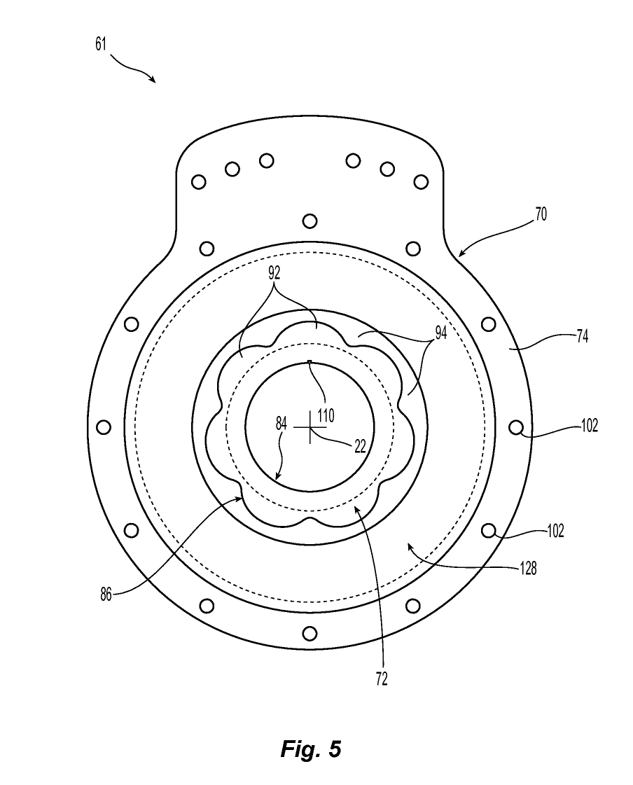

Those of ordinary skill in the art will recognize that reducing clearance C2 and distance D2 provided by second embodiment resolver 61 (FIG. 2), to match clearance Cl and distance D1 provided by first embodiment resolver 60 (FIG. 1), can facilitate a possible reduction in the axial length of housing 30 in second embodiment electric machine 21, thereby allowing machine 21 to become somewhat shorter than machine 20 in the axial dimension. With either first embodiment resolver 60 or second embodiment resolver 61, however, improved resolver shielding from EMI is provided relative to prior electric machines provided only with component machine shield 64. Moreover, use of a resolver 60 or 61, due to its shielding 112, 114 or 126, 128 may allow elimination of shield 64 altogether with no appreciable degradation in resolver EMI shielding effectiveness, which could similarly permit reduction in the axial length of housing 30 of first embodiment electric machine 20 or second embodiment electric machine 21, as well as provide attendant cost reductions associated with elimination of shield 64 itself and its mounting fasteners 66, 68. Moreover, as components of their respective resolvers 60, 61, front 112, 126 and rear 114, 128 shields provide protection against handling-related damage to delicate or functionally key areas of the resolvers, obviating the need for other protective covers such as the above-mentioned plastic covers used to protect prior resolvers from such damage. Notably, front shields 112, 126 and rear shields 114, 128 extend radially inward of resolver rotor outer perimeter 86, as best understood with reference to FIGS. 5 and 6 in which a dashed circle indicates the location of the inner circumference of rear shield 114, 128.

While exemplary embodiments have been disclosed hereinabove, the present disclosure is not limited to the disclosed embodiments. Instead, this application is intended to cover any variations, uses, or adaptations of the present disclosure using its general principles. Further, this application is intended to cover such departures from the present disclosure as come within known or customary practice in the art to which this present disclosure pertains and which fall within the limits of the appended claims.

What is claimed is:

1. An electric machine comprising:
a machine stator;
a machine rotor supported for relative rotation relative to the machine stator about an axis;
a variable reluctance resolver comprising a resolver stator having an annular resolver stator core rotatably fixed relative to the machine stator and surrounding the axis, and a resolver rotor rotatable in unison with the machine rotor and surrounded by the resolver stator core; and
resolver EMI shielding comprising first and second resolver shields disposed on opposite axial sides of the resolver stator core, the resolver shielding having a relative permeability of at least about 50.

2. The electric machine of claim 1, wherein the first and second resolver shields are separably assembled components of the electric machine.

3. The electric machine of claim 1, wherein the first and second resolver shields are components of the variable reluctance resolver.

4. The electric machine of claim 3, wherein the first and second resolver shields are separable components of the resolver stator.

5. The electric machine of claim 3, wherein the first and second resolver shields are integrally formed together and joined through the resolver stator core, whereby the first and second resolver shields are nonseparably integrated components of the resolver stator.

6. The electric machine of claim 1, wherein the resolver EMI shielding is formed of a plastic-type material having a relative permeability of at least about 50 and the first and second resolver shields are integrally formed together and joined through the resolver stator core.

7. The electric machine of claim 1, further comprising a machine shield located between the machine rotor and the variable reluctance resolver, the machine shield having a relative permeability of at least about 50, whereby EMI shielding of the variable reluctance resolver by the machine shield is supplemented by the resolver EMI shielding.

8. The electric machine of claim 1, further comprising a machine housing within which the machine stator, the machine rotor, and the variable reluctance resolver are disposed, the machine housing and machine stator rotatably fixed relative to each other, the resolver stator core and the resolver EMI shielding affixed to the machine housing.

9. The electric machine of claim 1, wherein the first and second resolver shields have flanges that superpose a respectively adjacent one of the opposite axial sides of the resolver stator core, the resolver stator core sandwiched between the flanges of the first and second resolver shields.

10. The electric machine of claim 1, wherein the resolver rotor has an inner perimeter and an outer perimeter interfacing the resolver stator core and radially outward of the inner perimeter, and at least one of the first and second resolver shields has a circumference radially inward of the resolver rotor outer perimeter.

11. The electric machine of claim 1, wherein the resolver rotor comprises a resolver rotor core having a first magnetic permeability and an isolating sleeve disposed radially between the resolver rotor core and the axis, the isolating sleeve having a second magnetic permeability substantially less than the first magnetic permeability.

12. The electric machine of claim 11, wherein the relative permeability of the isolating sleeve is no more than about 2.

13. A variable reluctance resolver comprising:
a resolver stator having an annular resolver stator core surrounding an axis;
a resolver rotor rotatable about the axis relative to the resolver stator and surrounded by the resolver stator core; and
resolver EMI shielding comprising first and second resolver shields disposed on opposite axial sides of the resolver stator core, the resolver shielding having a relative permeability of at least about 50.

14. The variable reluctance resolver of claim 13, wherein the first and second resolver shields are separable components of the resolver stator.

15. The variable reluctance resolver of claim 13, wherein the first and second resolver shields are integrally formed together and joined through the resolver stator core, whereby the first and second resolver shields are nonseparably integrated components of the resolver stator.

16. The variable reluctance resolver of claim 13, wherein the resolver EMI shielding is formed of a plastic-type material having a relative permeability of at least about 50 and the first and second resolver shields are integrally formed together and joined through the resolver stator core.

17. The variable reluctance resolver of claim 13, wherein the first and second resolver shields have flanges that superpose a respectively adjacent one of the opposite axial sides of the resolver stator core, the resolver stator core sandwiched between the flanges of the first and second resolver shields.

18. The variable reluctance resolver of claim 13, wherein the resolver rotor has an inner perimeter and an outer perimeter interfacing the resolver stator core and radially outward of the inner perimeter, and at least one of the first and second resolver shields has a circumference radially inward of the resolver rotor outer perimeter.

19. The variable reluctance resolver of claim 13, wherein the resolver rotor comprises a resolver rotor core having a first magnetic permeability and an isolating sleeve disposed radially between the resolver rotor core and the axis, the isolating sleeve having a second magnetic permeability substantially less than the first magnetic permeability.

20. The variable reluctance resolver of claim 19, wherein the relative permeability of the isolating sleeve is no more than about 2.
